(19) United States
(12) Patent Application Publication
(10) Pub. No.: US 2019/0276345 A1
(43) Pub. Date: Sep. 12, 2019

(54) PROCESS FOR TAILINGS REMEDIATION

(71) Applicant: DOW GLOBAL TECHNOLOGIES LLC, Midland, MI (US)

(72) Inventors: Lizbeth ROSTRO, Lake Jackson, TX (US); Wu CHEN, Lake Jackson, TX (US); Paul A. GILLIS, Lake Jackson, TX (US); Jason S. MOORE, Walnut Creek, CA (US); Michael K. POINDEXTER, Sugar Land, TX (US); Harpeet SINGH, Pearland, TX (US)

(73) Assignee: Dow Global Technologies LLC, Midland, MI (US)

(21) Appl. No.: 16/319,055

(22) PCT Filed: Sep. 11, 2017
(86) PCT No.: PCT/US2017/050905

§ 371 Date: Jan. 18, 2019

Related U.S. Application Data
(60) Provisional application No. 62/398,615, filed on Sep. 23, 2016.

(51) Int. Cl. C02F 11/147; C10G 33/04; C10G 33/06; C10G 1/04; C02F 11/127; C02F 1/56; C02F 1/52

(52) U.S. Cl. CPC C02F 11/147; C10G 33/04; C10G 33/06; C10G 1/045; C02F 11/127; C02F 2103/10; C02F 1/5272; C10G 2300/1003; C10G 2300/1033; C10G 2300/208; C10G 2300/80; C02F 1/56

(57) ABSTRACT

The present invention relates to a process for flocculating and dewatering an aqueous mineral suspension. Said process comprises mixing a powdered poly(ethylene oxide) (co)polymer with the aqueous mineral suspension. Said method is particularly useful for the treatment of suspensions of particulate material, especially waste mineral slurries, especially for the treatment of tailings and other waste material resulting from mineral processing, in particular, the processing of oil sands tailings.

### FIELD OF THE INVENTION

The present invention relates to a process for treating aqueous mineral suspensions, especially waste mineral slurries, using a powdered polymeric flocculant composition, preferably comprising a poly(ethylene oxide) homo- or copolymer. The process of the present invention is particularly suitable for the treatment of tailings and other waste material resulting from mineral processing, in particular, processing of oil sands tailings.

### BACKGROUND OF THE INVENTION

Fluid tailings streams derived from mining operations, such as oil sands mining operations, are typically composed of water and solid particles. In order to recover the water and consolidate the solids, solid/liquid separation techniques must be applied. In oil sands processing a typical fresh tailings stream comprises water, sand, silt, clay and residual bitumen. Oil sands tailings typically comprise a substantial amount of fine particles (which are defined as solids that are less than 44 microns).

The bitumen extraction process utilizes hot water and chemical additives such as sodium hydroxide or sodium citrate to remove the bitumen from the ore body. The side effect of these chemical additives is that they can change the inherent water chemistry. The inorganic solids as well as the residual bitumen in the aqueous phase acquire a negative charge. Due to strong electrostatic repulsion, the fine particles form a stabilized suspension that does not readily settle by gravity, even after a considerable amount of time. In fact, if the suspension is left alone for 3-5 years, a gel-like layer known as mature fine tailings (MFT) will be formed and this type of tailings is very difficult to consolidate even with current technologies.

Recent methods for dewatering MFT are disclosed in WO 2011/032258 and WO 2001/032253, which describe in-line addition of a flocculant solution, such as a polyacrylamide (PAM), into the flow of oil sands tailings, through a conduit such as a pipeline. Once the flocculant is dispersed into the oil sands tailings, the flocculant and tailings continue to mix as they travel through the pipeline and the dispersed clays, silt, and sand bind together (flocculate) to form larger structures (flocs) that can be separated from the water when ultimately deposited in a disposal area. However, the degree of mixing and shearing is dependent upon the flow rate of the materials through the pipeline as well as the length of the pipeline. Thus, any changes in the fluid properties or flow rate of the oil sands fine tailings may have an effect on both mixing and shearing and ultimately flocculation. Thus, if one has a length of open pipe, it would be difficult to control flocculation because of the difficulty in independently controlling both the shear rate and residence time simply by changing the flow rate.

CA Patent Application No. 2,512,324 suggests addition of water-soluble polymers to oil sands fine tailings during the transfer of the tailings as a fluid to a disposal area, for example, while the tailings are being transferred through a pipeline or conduit to a disposal site. However, once again, proper mixing of polymer flocculant with tailings is difficult to control due to changes in the flow rate and fluid properties of the tailings material through the pipeline.

US Publication No. 2013/0075340 discloses a process for flocculating and dewatering oil sands tailings comprising adding oil sands tailings as an aqueous slurry to a stirred tank reactor; adding an effective amount of a polymeric flocculant solution, such as charged or uncharged polyacrylamides, to the stirred tank reactor containing the oil sands tailings, dynamically mixing the flocculant solution and oil sands tailings for a period of time sufficient to form a gel-like structure; subjecting the gel-like structure to shear conditions in the stirred tank reactor for a period of time sufficient to break down the gel-like structure to form flocs and release water; and removing the flocculated oil sands fine tailings from the stirred tank reactor when the maximum yield stress of the flocculated oil sands fine tailings begins to decline but before the capillary suction time of the flocculated oil sands fine tailings begins to substantially increase from its lowest point.

CA 2876660 discloses the addition of a mixture of a polyacrylamide flocculant solution and a salt of an organic acid for treating a tailings stream.

While polyacrylamides are generally useful for fast consolidation of tailings solids, they are highly dose sensitive towards the flocculation of fine particles and it is challenging to find conditions under which a large proportion of the fine particles are flocculated. As a result, the water recovered from a PAM consolidation process is often of poor quality and may not be suitable for recycling because of high fines content in the water. Additionally, tailings treated with PAM are shear sensitive so transportation of treated thickened tailings to a dedicated disposal area (DDA) and general materials handling can become a further challenge.

Alternatively, polyethylene oxide (PEO) is known as a flocculant for mine tailings capable of producing a lower turbidity supernatant as compared to PAM, for example see U.S. Pat. Nos. 4,931,190; 5,104,551; 6,383,282; WO 2011/070218; and WO 2016/019214; Sharma, S. K., Scheiner, B. J., and Smelley, A. G., (1992). Dewatering of Alaska Pacer Effluent Using PEO. United States Department of the Interior, Bureau of Mines, Report of Investigation 9442; and Sworska, A., Laskowski, J. S., and Cymerman, G. (2000). Flocculation of the Syncrude Fine Tailings Part II. Effect of Hydrodynamic Conditions. Int. J. Miner. Process., 60, pp. 153-161. However, PEO polymers have not found widespread commercial use in oil sands tailing treatment because of mixing and processing challenges resulting from its high viscosities with clay-based slurries.

In spite of the numerous processes and polymeric flocculating agents used therein, there is still a need for a flocculating process to further improve the settling and consolidation of suspensions of materials as well as further improve upon the dewatering of suspensions of waste solids that have been transferred as a fluid or slurry to a settling area for disposal. In particular, it would be desirable to provide a more effective treatment of waste suspensions, such as oil sands tailings, transferred to disposal areas ensuring improved concentration of solids and improved clarity of released water with improved shear stability and wider dose tolerance.

### BRIEF SUMMARY OF THE INVENTION

The present invention is a process for flocculating and dewatering an aqueous mineral suspension, comprising the steps: (i) providing an in-line flow of an aqueous mineral suspension through a pipe, (ii) introducing a powdered flocculant composition consisting of a poly(ethylene oxide) (co)polymer and optionally one or more additive that is not a flocculant composition into the aqueous mineral suspension flowing through the pipe, (iii) mixing the powdered flocculant composition and the aqueous mineral suspension, (iv) flowing the mixture of aqueous mineral suspension and flocculant composition through a pipe for further treatment and/or to a dedicated disposal area, and (v) forming a flocculated aqueous mineral suspension, wherein step (v) may occur before and/or during and/or after step (iv).

In one embodiment, the process of the present invention disclosed herein above further comprises the step: (vi) adding the flocculated aqueous mineral suspension to at least one centrifuge to dewater the flocculated aqueous mineral suspension and form a high solids cake and a low solids centrate.

In one embodiment, the process of the present invention disclosed herein above further comprises the step: (vii) adding the flocculated aqueous mineral suspension to a thickener to dewater the flocculated aqueous mineral suspension and produce thickened flocculated aqueous mineral suspension and clarified water.

In one embodiment of the process of the present invention disclosed herein above the dedicated disposal area is a sloped deposition site and further comprises the step: (viii) spreading the mixture of aqueous mineral suspension and flocculant composition and/or flocculated aqueous mineral suspension as a thin layer onto the sloped deposition site.

In one embodiment of the process of the present invention disclosed herein above, the dedicated disposal area is a deep ditch.

In one embodiment of the process of the present invention disclosed herein above, the dedicated disposal area is at least one deep pit accelerated dewatering cell.

In one embodiment of the process of the present invention disclosed herein above, the poly(ethylene oxide) (co)polymer composition comprises a poly(ethylene oxide) homopolymer, a poly(ethylene oxide) copolymer, or mixtures thereof.

In one embodiment of the process of the present invention disclosed herein above, the poly(ethylene oxide) copolymer is a copolymer of ethylene oxide with one or more of epichlorohydrin, propylene oxide, butylene oxide, styrene oxide, an epoxy functionalized hydrophobic monomer, glycidyl ether functionalized hydrophobic monomer, a silane-functionalized glycidyl ether monomer, or a siloxane-functionalized glycidyl ether monomer.

In one embodiment of the process of the present invention disclosed herein above, the poly(ethylene oxide) (co)polymer has a molecular weight of equal to or greater than 1,000,000 Da.

### BRIEF DESCRIPTION OF THE DRAWINGS

FIG. 1 is a schematic of a conventional process for treating aqueous mineral suspensions.

FIG. 2 is a schematic of embodiments A to D of the process of the present invention for treating aqueous mineral suspensions.

FIG. 3 shows a plot of the dewatering rate of MFT treated with a flocculant composition of the invention and a flocculant composition not of the invention.

FIG. 4 shows the viscosity versus time for MFT treated with a flocculant of the present invention.

FIG. 5 shows a plot of the dewatering rate of MFT circulated in a flow loop treated with a flocculant composition of the invention for two different mixing times.

FIG. 6 shows a plot of the dewatering rate of MFT circulated in a flow loop treated with a flocculant composition of the invention at three different dosages.

### DETAILED DESCRIPTION OF THE INVENTION

According to the present invention, we provide a process for dewatering an aqueous mineral suspension comprising introducing into the suspension a powdered flocculating composition comprising a poly(ethylene oxide) homopolymer, a poly(ethylene oxide) copolymer, or mixtures thereof, herein after collectively referred to as “poly(ethylene oxide) (co)polymer”. Typically, the material to be flocculated may be derived from or contain, tailings, thickener underflows, or unthickened plant waste streams, for instance other mineral tailings, slurries, or slimes, including phosphate, diamond, gold slimes, mineral sands, tails from zinc, lead, copper, silver, uranium, nickel, iron ore processing, coal, oil sands or red mud. The material may be solids settled from the final thickener or wash stage of a mineral processing operation. Thus the material desirably results from a mineral processing operation. Preferably the material comprises tailings. Preferably the mineral material would be selected from red mud and tailings containing clay, such as oil sands so tailings, etc.

The oil sands tailings or other mineral suspensions may have a solids content in the range 5 percent to 80 percent by weight. The slurries or suspensions often have a solids content in the range of 10 percent to 70 percent by weight, for instance 25 percent to 40 percent by weight. The sizes of particles in a typical sample of the fine tailings are substantially less than 45 microns, for instance about 95 percent by weight of material is particles less than 20 microns and about 75 percent is less than 10 microns. The coarse tailings are substantially greater than 45 microns, for instance about 85 percent is greater than 100 microns but generally less than 10,000 microns. The fine tailings and coarse tailings may be present or combined together in any convenient ratio provided that the material remains pumpable.

The dispersed particulate solids may have a unimodal, bimodal, or multimodal distribution of particle sizes. The distribution will generally have a fine fraction and a coarse fraction, in which the fine fraction peak is substantially less than 44 microns and the coarse (or non-fine) fraction peak is substantially greater than 44 microns.

The flocculant composition of the process of the present invention consists of a polymeric flocculant, poly(ethylene oxide) homopolymer, a poly(ethylene oxide) copolymer, or mixtures thereof. Poly(ethylene)oxide (co)polymers and methods to make said polymers are known, for example see WO 2013116027. In one embodiment of the present invention, a zinc catalyst, such as disclosed in U.S. Pat. No. 4,667,013, can be employed to make the poly(ethylene oxide) (co)polymers of the present invention. In a preferred embodiment the catalyst used to make the poly(ethylene oxide) (co)polymers of the present invention is a calcium catalyst such as those disclosed in U.S. Pat. Nos. 2,969,402; 3,037,943; 3,627,702; 4,193,892; and 4,267,309, all of which are incorporated by reference herein in their entirety.

A preferred zinc catalyst is a zinc alkoxide catalyst as disclosed in U.S. Pat. No. 6,979,722, which is incorporated by reference herein in its entirety.

A preferred alkaline earth metal catalyst is referred to as a “modified alkaline earth hexammine” or a “modified alkaline earth hexammoniate” the technical terms “ammine” and “ammoniate” being synonymous. A modified alkaline earth hexammine useful for producing the poly(ethylene oxide) (co)polymer of the present invention is prepared by admixing at least one alkaline earth metal, preferably calcium metal, strontium metal, or barium metal, zinc metal, or mixtures thereof, most preferably calcium metal; liquid ammonia; an alkylene oxide; which is optionally substituted by aromatic radicals, and an organic nitrile having at least one acidic hydrogen atom to prepare a slurry of modified alkaline earth hexammine in liquid ammonia; continuously transferring the slurry of modified alkaline earth hexammine in liquid ammonia into a stripper vessel and continuously evaporating ammonia, thereby accumulating the modified catalyst in the stripper vessel; and upon complete transfer of the slurry of modified alkaline earth hexammine into the stripper vessel, aging the modified catalyst to obtain the final polymerization catalyst. In a preferred embodiment of the alkaline earth metal catalyst of the present invention described herein above, the alkylene oxide is propylene oxide and the organic nitrile is acetonitrile.

A catalytically active amount of alkaline earth metal catalyst is used in the process to make the poly(ethylene oxide) (co)polymer of the present invention, preferably the catalyst is used in an amount of from 0.0004 to 0.0040 g of alkaline earth metal per gram of epoxide monomers (combined weight of all monomers, e.g., ethylene oxide, substituted ethylene oxide, and silane- or siloxane-functionalized glycidyl ether monomers), preferably 0.0007 to 0.0021 g of alkaline earth metal per gram of epoxide monomers, more preferably 0.0010 to 0.0017 g of alkaline earth metal per gram of epoxide monomers, and most preferably 0.0012 to 0.0015 g of alkaline earth metal per gram of epoxide monomer.

The catalysts may be used in dry or slurry form in a conventional process for polymerizing an epoxide, typically in a suspension polymerization process. The catalyst can be used in a concentration in the range of 0.02 to 10 percent by weight, such as 0.1 to 3 percent by weight, based on the weight of the epoxide monomers feed.

The polymerization reaction can be conducted over a wide temperature range. Polymerization temperatures can be in the range of from −30° C. to 150° C. and depends on various factors, such as the nature of the epoxide monomer(s) employed, the particular catalyst employed, and the concentration of the catalyst. A typical temperature range is from 0° C. to 150° C.

The pressure conditions are not specifically restricted and the pressure is set by the boiling points of the diluent and comonomers used in the polymerization process.

In general, the reaction time will vary depending on the operative temperature, the nature of the comonomer(s) employed, the particular catalyst and the concentration employed, the use of an inert diluent, and other factors. As defined herein copolymer may comprise more than one comonomer, for instance there can be two comonomers, three comonomers, four comonomers, five comonomers, and so on. Suitable comonomers include, but are not limited to, epichlorohydrin, propylene oxide, butylene oxide, styrene oxide, an epoxy functionalized hydrophobic monomer, a glycidyl ether or glycidyl propyl functionalized hydrophobic monomer, a silane-functionalized glycidyl ether or glycidyl propyl monomer, a siloxane-functionalized glycidyl ether or glycidyl propyl monomer, an amine or quaternary amine functionalized glycidyl ether or glycidyl propyl monomer, and a glycidyl ether or glycidyl propyl functionalized fluorinated hydrocarbon containing monomer. Specific comonomers include but are not limited to, 2-ethylhexylglycidyl ether, benzyl glycidyl ether, nonylphenyl glycidyl ether, 1,2-epoxydecane, 1,2-epoxyoctane, 1,2-epoxytetradecane, glycidyl 2,2,3,3,4,4,5,5-octafluoropentyl ether, glycidyl 2,2,3,3-tetrafluoropropyl ether, octylglycidyl ether, decylglycidyl ether, 4-chlorophenyl glycidyl ether, 1-(2,3-epoxypropyl)-2-nitroimidazole, 3-glycidylpropyl triethoxysilane, 3-glycidoxypropyldimethylethoxysilane, diethoxy(3-glycidyloxypropyl)methylsilane, poly(dimethylsiloxane) monoglycidylether terminated, and (3-glycidylpropyl)trimethoxysilane. Polymerization times can be run from minutes to days depending on the conditions used. Preferred times are 1 h to 10 h.

The ethylene oxide may be present in an amount equal to or greater than 2 weight percent, preferably equal to or greater than 5 weight percent, and more preferably in an amount equal to or greater than 10 weight percent based on the total weight of said copolymer. The ethylene oxide may be present in an amount equal to or less than 98 weight percent, preferably equal to or less than 95 weight percent, and more preferably in an amount equal to or less than 90 weight percent based on the total weight of said copolymer.

The one or more comonomer may be present in an amount equal to or greater than 2 weight percent, preferably equal to or greater than 5 weight percent, and more preferably in an amount equal to or greater than 10 weight percent based on the total weight of said copolymer. The one or more comonomer may be present in an amount equal to or less than 98 weight percent, preferably equal to or less than 95 weight percent, and more preferably in an amount equal to or less than 90 weight percent based on the total weight of said copolymer. If two or more comonomers are used, the combined weight percent of the two or more comonomers is from 2 to 98 weight percent based on the total weight of said poly(ethylene oxide) copolymer.

The copolymerization reaction preferably takes place in the liquid phase. Typically, the polymerization reaction is conducted under an inert atmosphere, e.g., nitrogen. It is also highly desirable to affect the polymerization process under substantially anhydrous conditions. Impurities such as water, aldehyde, carbon dioxide, and oxygen which may be present in the epoxide feed and/or reaction equipment should be avoided. The poly(ethylene oxide) copolymers of this invention can be prepared via the bulk polymerization, suspension polymerization, or the solution polymerization route, suspension polymerization being preferred.

The copolymerization reaction can be carried out in the presence of an inert organic diluent such as, for example, aromatic hydrocarbons, benzene, toluene, xylene, ethylbenzene, and chlorobenzene; various oxygenated organic compounds such as anisole, the dimethyl and diethyl ethers of ethylene glycol, of propylene glycol, and of diethylene glycol; normally-liquid saturated hydrocarbons including the open chain, cyclic, and alkyl-substituted cyclic saturated hydrocarbons such as pentane (e.g. isopentane), hexane, heptane, various normally-liquid petroleum hydrocarbon fractions, cyclohexane, the alkylcyclohexanes, and decahydronaphthalene.

Unreacted monomeric reagent oftentimes can be recovered from the reaction product by conventional techniques such as by heating said reaction product under reduced pressure. In one embodiment of the process of the present invention, the poly(ethylene oxide) copolymer product can be recovered from the reaction product by washing said reaction product with an inert, normally-liquid organic diluent, and subsequently drying same under reduced pressure at slightly elevated temperatures.

In another embodiment, the reaction product is dissolved in a first inert organic solvent, followed by the addition of a second inert organic solvent which is miscible with the first solvent, but which is a non-solvent for the poly(ethylene oxide) copolymer product, thus precipitating the copolymer product. Recovery of the precipitated copolymer can be effected by filtration, decantation, etc., followed by drying same as indicated previously. Poly(ethylene oxide) copolymers will have different particle size distributions depending on the processing conditions. The poly(ethylene oxide) copolymer can be recovered from the reaction product by filtration, decantation, etc., followed by drying said granular poly(ethylene oxide) copolymer under reduced pressure at slightly elevated temperatures, e.g., 30° C. to 40° C. If desired, the granular poly(ethylene oxide) copolymer, prior to the drying step, can be washed with an inert, normally-liquid organic diluent in which the granular polymer is insoluble, e.g., pentane, hexane, heptane, cyclohexane, and then dried as illustrated above.

Unlike the granular poly(ethylene oxide) copolymer which results from the suspension polymerization route as illustrated herein above, a bulk or solution copolymerization of ethylene oxide with one or more comonomer yields a non-granular resinous poly(ethylene oxide) copolymer which is substantially an entire polymeric mass or an agglomerated polymeric mass or it is dissolved in the inert, organic diluent. It is understood, of course, that the term “bulk polymerization” refers to polymerization in the absence of an inert, normally-liquid organic diluent, and the term “solution polymerization” refers to polymerization in the presence of an inert, normally-liquid organic diluent in which the monomer employed and the polymer produced are soluble.

The individual components of the polymerization reaction, i.e., the epoxide monomers, the catalyst, and the diluent, if used, may be added to the polymerization system in any practicable sequence as the order of introduction is not crucial for the present invention.

The use of the alkaline earth metal catalyst described herein above in the polymerization of epoxide monomers allows for the preparation of exceptionally high molecular weight polymers. Without being bound by theory it is believed that the unique capability of the alkaline earth metal catalyst to produce longer polymer chains than are otherwise obtained in the same polymerization system using the same raw materials with a non-alkaline earth metal catalyst is due to the combination of higher reactive site density (which is considered activity) and the ability to internally bind catalyst poisons.

Suitable poly(ethylene oxide) homopolymers and poly(ethylene oxide) copolymers useful in the method of the present invention have a weight average molecular weight equal to or greater than 100,000 daltons (Da) and equal to or less than 15,000,000 Da, preferably equal to or greater than 1,000,000 Da and equal to or less than 8,000,000 Da.

Poly(ethylene oxide) (co)polymers are particularly suitable for use in the method of the present invention as flocculation agents for suspensions of particulate material, especially waste mineral slurries. Poly(ethylene oxide) (co)polymers are particularly suitable for the method of the present invention to treat tailings and other waste material resulting from mineral processing, in particular, processing of oil sands tailings.

Suitable amounts of the flocculant composition comprising the poly(ethylene oxide) (co)polymer to be added to the mineral suspensions range from 10 grams to 10,000 grams per ton of mineral solids. Generally the appropriate dose can vary according to the particular material and material solids content. Preferably, the amount of the flocculant composition comprising the poly(ethylene oxide) (co)polymer is added in an amount equal to or greater than 10 g/ton of mineral solids, more preferably in an amount equal to or greater than 30 g/ton of mineral solids, more preferably in an amount equal to or greater than 70 g/ton of mineral solids, more preferably in an amount equal to or greater than 100 g/ton of mineral solids, and more preferably in an amount equal to or greater than 150 g/ton of mineral solids. Preferably, the amount of the flocculant composition comprising the poly(ethylene oxide) (co)polymer is added in an amount equal to or less than 10,000 g/ton of mineral solids, more preferably in an amount equal to or less than 7,500 g/ton of mineral solids, more preferably in an amount equal to or less than 5,000 g/ton of mineral solids, more preferably in an amount equal to or less than 2,500 g/ton of mineral solids, more preferably in an amount equal to or greater than 1,000 g/ton of mineral solids, and more preferably in an amount equal to or greater than 500 g/ton of mineral solids.

The flocculant composition comprising a poly(ethylene oxide) (co)polymer may be added to the suspension of particulate mineral material, e.g., the tailings slurry, in solid particulate form, an aqueous solution that has been prepared by dissolving the poly(ethylene oxide) (co)polymer into water, or an aqueous-based medium, or a suspended slurry in a solvent.

In the process of the present invention, the flocculant composition comprising a poly(ethylene oxide) (co)polymer do not further comprise any other type of flocculant (e.g., polyacrylates, polymethacrylates, polyacrylamides, partially-hydrolyzed polyacrylamides, cationic derivatives of polyacrylamides, polydiallyldimethylammonium chloride (pDADMAC), copolymers of DADMAC, cellulosic materials, chitosan, sulfonated polystyrene, linear and branched polyethyleneimines, polyvinylamines, etc.) or other type of additive typical for flocculant compositions. In other words, the only flocculant in the flocculant composition of the present invention consists of one or more poly(ethylene oxide) (co)polymer.

However, the flocculant composition of the present invention may contain other additives that are not flocculants. For example, one or more coagulant, such as salts of calcium (e.g., gypsum, calcium oxide, and calcium hydroxide), aluminum (e.g., aluminum chloride, sodium aluminate, and aluminum sulfate), iron (e.g., ferric sulfate, ferrous sulfate, ferric chloride, and ferric chloride sulfate), magnesium (e.g., magnesium carbonate,) other multi-valent cations and pre-hydrolyzed inorganic coagulants, may also be used in conjunction with the poly(ethylene oxide) (co)polymer.

In one embodiment, the present invention relates to a process for dewatering oil sands tailings. As used herein, the term “tailings” means tailings derived from oil sands extraction operations and containing a fines fraction. The term is meant to include fluid fine tailings (FFT) and/or mature fine tailings (MFT) tailings from ongoing extraction operations (for example, thickener underflow or froth treatment tailings) which may bypass a tailings pond and from tailings ponds. The oil sands tailings will generally have a solids content of 10 to 70 weight percent, or more generally from 25 to 40 weight percent, and may be diluted to 20 to 25 weight percent with water for use in the present process.

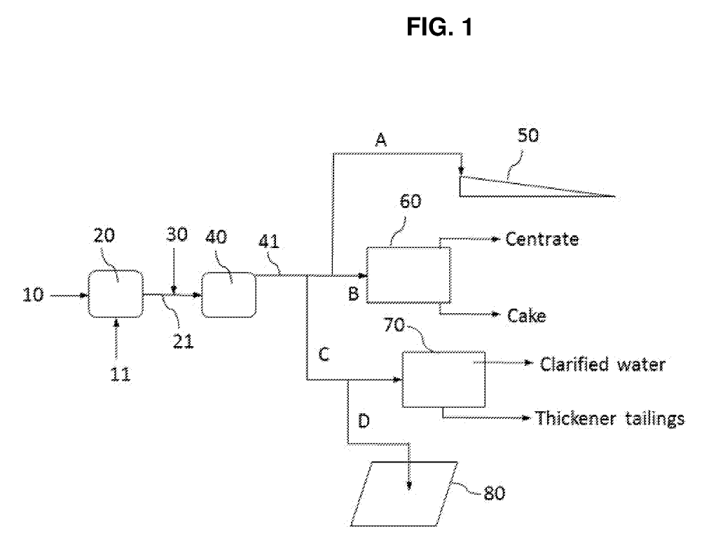

A schematic of a conventional process to flocculate and dewater an aqueous mineral suspension is shown in FIG. 1. A flocculant composition comprising a poly(ethylene oxide) (co)polymer, either powdered or in solution (referred herein after to as “PEO”) 10 and water 11, for example process water, are added to the polymer hydration unit 20. The PEO is dispersed in the process water and they are mixed to form an aqueous PEO mixture. This mixing operation may include pipe line blending with or without static mixing elements, fluid jet mixing of streams, in-line dynamic mixers and agitated stirred tanks.

The aqueous mixture of PEO leaves the hydration unit 20 via pipe 21. The aqueous mineral suspension 30 containing solids, such as oil sands mature fine tailings (MFT), is added to the aqueous mixture of PEO prior to entering an in-line mixer 40. The aqueous mixture of PEO and the MFT are mixed in an in-line mixer 40 then leave through line 41. The mixer 40 may be a static mixer, a dynamic mixer, a small tank, an enlarged diameter section of piping, or a length of pipe with or without bends to create a favorable hydrodynamic environment for mixing the MFT and PEO. Once the mixed solution of MFT and PEO leaves the in-line mixer 40 through line 41 it may be further conditioned, treated and/or deposited in a deposited in a dedicated disposal area (DDA). The mixed solution of MFT and PEO may or may not build floc in the line 41 after it leaves it leaves the mixer 40, before/after/or during further treatment, and/or before or after being deposited in a dedicated disposal area.

In FIG. 1, possible further treatment and dedicated disposal areas for the flocculated MFT include, but are not limited to, A a thin lift sloped deposition site 50, (B) a centrifuge 60, (C) a thickener 70, or (D) a deep pit accelerated dewatering cell 80.

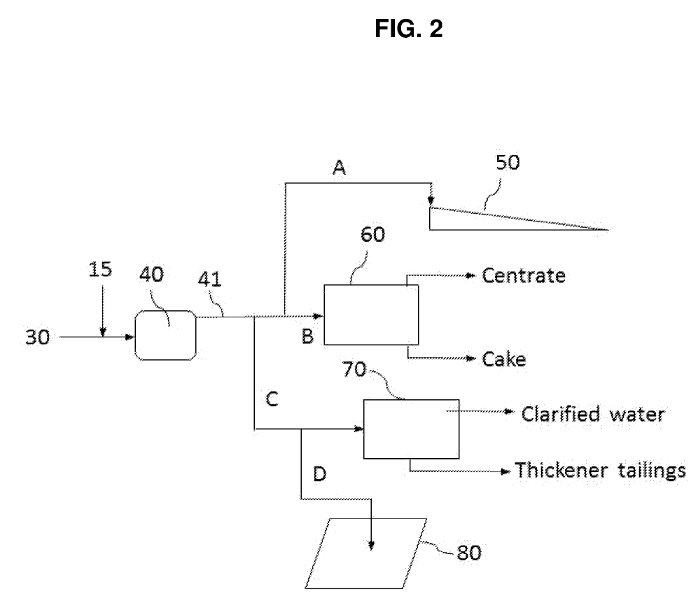

The improvement in the process of the present invention involves the elimination of the hydration unit 20 and PEO hydration step by adding the PEO composition as a powder directly to the MFT stream, FIG. 2. There are many advantages to treating the tailings streams using a PEO powder instead of a polymer solution. First, the polymer hydration stage will be eliminated from the overall remediation process resulting in the elimination of the initial capital investment and the continual operation and maintenance costs. Polymer hydration units periodically experience unplanned and unwanted mechanical downtime issues. Such instances would be eliminated with the present process. In addition, the elimination of this equipment will eliminate the need for the operator to pump process water to the hydration stage. Moreover, the treatment of the tailings streams using a polymer solution results in a significant increase in volume of the treated tailings stream and water consumption. The volume of the treated tailings streams can increase substantially depending on the treatment dosage and concentration of the starting tailings stream. For example, a 35 wt % tailings stream, when treated with a 0.4 wt % polymer solution at 1900 ppm based on dry solids, will increase 20% by volume. This volume increase will need to be accounted for in the subsequent tailings treatment facility (e.g., the dedicated disposal area). Moreover, the amount of water necessary to treat a tailings stream by the process of the present invention is significantly reduced.

In the process of the present invention powdered PEO composition 15 is added directly to the MFT stream in a pipeline and is allowed to mix. The powdered PEO composition and MFT can mix in the pipeline carrying the MFT or preferably the process comprises an in-line mixer 40. The mixer 40 may be a static mixer, a dynamic mixer, a small tank, an enlarged diameter section of piping, or a length of pipe with or without bends to create a favorable hydrodynamic environment for mixing the MFT and PEO. Preferably mixing is allowed to take place for at least 5 seconds, preferably at least 10 seconds, preferably at least 15 seconds, more preferably at least 20 seconds, more preferably at least 30 seconds, and more preferably at least 45 seconds prior to deposition in a dedicated disposal area. The upper time limit for mixing is whatever is practical for the time to transport the mixture to a deposition area for a particular process, but typically, an adequate time for mixing is equal to or less than an hour, equal to or less than 30 minutes, more preferably equal to or less than 10 minutes, more preferably equal to or less than 5 minutes more preferably less than 1 minute.

After leaving the in-line mixer 40 the mixed solution of MFT and PEO composition exits through line 41. After the mixed solution of MFT and PEO composition leaves the in-line mixer 40 through line 41 it be further conditioned, treated and/or deposited in a deposited in a dedicated disposal area (DDA).

In one embodiment, the mixture of an aqueous mineral suspension and flocculant composition builds floc before further treatment and/or deposition in a dedicated disposal area.

In another embodiment of the present invention, the mixture of an aqueous mineral suspension and flocculant composition builds floc after further treatment and/or deposition in a dedicated disposal area.

In yet another embodiment of the present invention, the mixture of an aqueous mineral suspension and flocculant composition builds floc in the pipeline after leaving the in-line mixer and continues to build floc after further treatment and/or deposition in a dedicated disposal area.

Preferably, the flocs which result from the process of the present invention have an average size between 10 to 50 microns. Preferably, the average floc size is equal to or greater than 1 micron, more preferably equal to or greater than 5 microns, more preferably equal to or greater than 10 microns, more preferably equal to or greater than 15 microns, even more preferably equal to or greater than 25 microns. Preferably, the average floc size is equal to or less than 1000 microns, more preferably equal to or less than 500 microns, more preferably equal to or less than 250 microns, more preferably equal to or less than 100 microns, even more preferably equal to or less than 75 microns. A convenient way to measure floc size is from microscopic photos.

In one embodiment of the process of the present invention (A) shown in FIG. 2, the mixture of an aqueous mineral suspension and flocculant composition and/or flocculated MFT is transported to a thin lift sloped deposition site 50 having a slope of 1 percent to 4 percent to allow water drainage. This water drainage allows the material to dry at a more rapid rate and reach trafficability levels sooner. Additional layers can be added and allowed to drain accordingly.

In another embodiment of the process of the present invention (B) shown in FIG. 2, the flocculated MFT is transferred to a centrifuge 60. A centrifuge cake solid containing the majority of the fines and a relatively clear centrate having low solids concentrations are formed in the centrifuge 60. The centrifuge cake can then be transported, for example, by trucks, and deposited in a drying cell.

In a further embodiment of the process of the present invention (C) shown in FIG. 2, the flocculated MFT is placed into a thickener 70, said thickener 70 may comprise rakes (not shown in FIG. 2), to produce clarified water and thickened tailings for further disposal in the dedicated disposal area.

Yet a further embodiment of the process of the present invention (D) is shown in FIG. 2, the mixture of an aqueous mineral suspension and flocculant composition and/or flocculated MFT is deposited into, preferably at a controlled rate, in a deep pit accelerated dewatering cell 80, for example a tailings pit, basin, dam, culvert, ditch, or pond, or the like which acts as a fluid containment structure. The containment structure may be filled with flocculated MFT continuously or the treated MFT can be deposited in layers of varying thickness. The water released may be removed using pumps (not shown in FIG. 2).

Not to be held to any particular theory, we believe the nature of the floc of the present process reduces the amount of water trapped versus large floc structures as with conventional flocculants, thus the water is more easily released from the solids as they settle and consolidate. Moreover, the process of the present invention produces a continual dewatering system in contrast to the conventional MFT flocculation processes where the water is principally released in the initial few hours after the deposition process. The process of the present invention also avoids multiple conditioning steps taught in conventional flocculation processes. Furthermore, the floc is significantly more tolerant of high shear conditions and can be transported and handled with reduced floc breakage/fines generation which reduce dewatering performance. Dewatering is typically determined using gravity settling in graduated cylinders, capillary suction time (CST) measurement, centrifugation followed by measuring the resultant height of solids or a large strain consolidometer. Gravity settling can be performed in a large graduated cylinder where the mud height is captured as a function of time using digital image collection and analysis. The mud height can then be used to calculate percent solids from the initial slurry solid content. Unless otherwise noted, dewatering reported herein is determined by gravity settling in graduated cylinders.

### EXAMPLES

A mature fine tailings (MFT) stream from northern Alberta, Canada comprising 38 weight percent solids is mixed using an A310 impeller on a Caframo overhead impeller mixer (used for all mixing unless otherwise stated). 200 mL of the MFT is premixed for 3 hours at 350 RPM forming a deep vortex. The MFT is covered during the stirring process to prevent the loss of any water while mixing and as such changing the material properties. After 3 hours of agitation, a powdered flocculant composition is added to the top edge of the vortex at a continuous rate for 120 seconds. The addition point of the powder and addition rate are critical in preventing the formation of gel aggregates of the powder

### Example 1

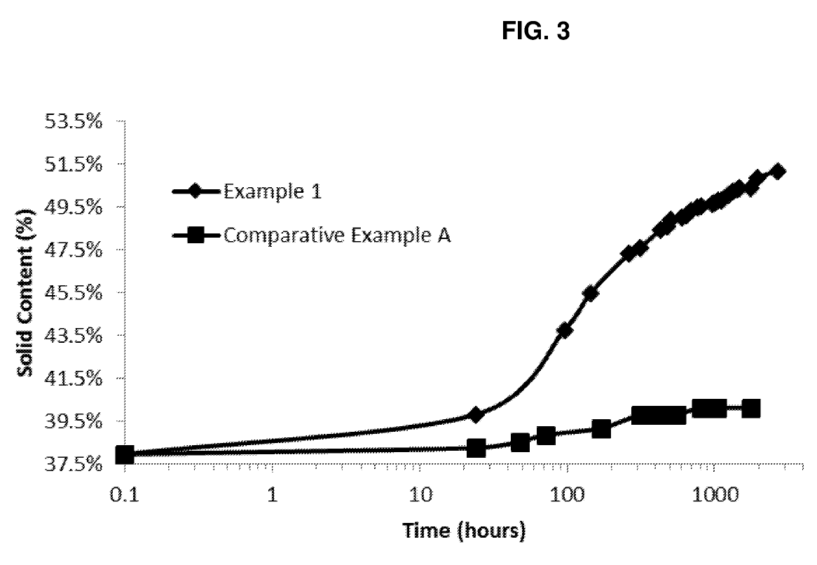

Using the process described above, the MFT is treated with a powdered flocculant composition consisting of poly (ethylene oxide) homopolymer having a weight average molecular weight of 8,000,000 Da available as POLYOX™ WSR 308 poly(ethylene oxide) polymer from The Dow Chemical Company. After the polymer is added, the MFT is stirred for an additional 8 minutes at the same mixing speed. After the 8 minutes of stirring, the sample is then transferred to a graduated cylinder for the monitoring of the dewatering FIG. 3.

### Comparative Example A

Using the process described above, the MFT is treated with a conventional powdered flocculant (ZETAG™ 4125 from BASF) solution consisting of 1% partially hydrolyzed polyacrylamide (HPAM) with a very high molecular weight. The viscosity of the mixture was 2,300 cP. The MFT is stirred for an additional 8 minutes at the same mixing speed. After the 8 minutes of stirring, the sample is then transferred to a graduated cylinder for the monitoring of the dewatering FIG. 3.

### Example 2

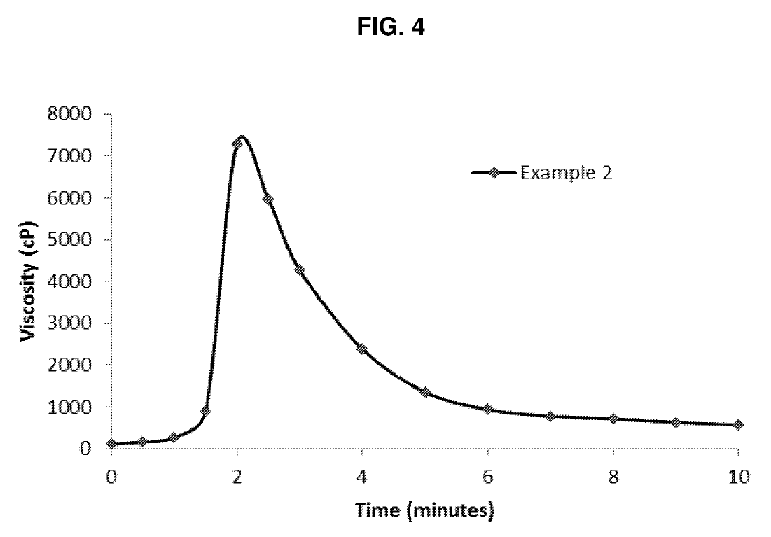

Using the process described above, the MFT is treated with a powdered flocculant composition consisting of POLYOX WSR 308 poly(ethylene oxide) polymer. The polymer powder is added to agitated MFT for a total of 120 seconds. It is then mixed for an additional 8 minutes. During the first three minutes, the addition of polymer powder is stopped every 30 seconds and the viscosity of the mixture is measured using a Brookfield DV3T rheometer with a V-73 attachment at 100 RPM. Thereafter the viscosity is measured every 1 minute for the duration of the treatment (total of 10 minutes). After the 120 second addition of the powder, the viscosity reaches the maximum value which corresponds to the formation of a gel-like structure. For times beyond the first 120 seconds, the viscosity decreases as the mixing time increases FIG. 4.

### Examples 3 and 4

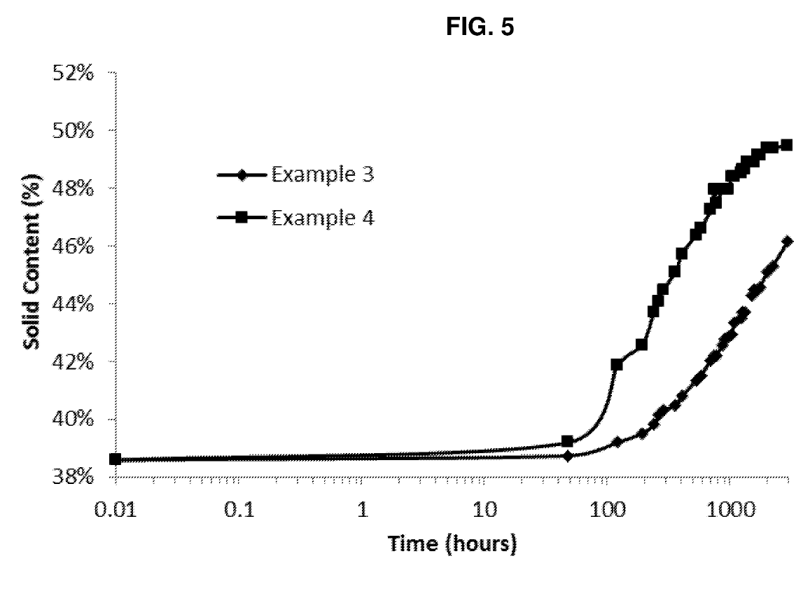

The MFT is treated with a powdered flocculant composition consisting of POLYOX WSR 308 poly(ethylene oxide) polymer. In Example 3, a stream of MFT is treated using a flow loop with a volume of 1 L, where the MFT/polymer mixture recirculated through an in-line static mixer as driven by a peristaltic pump. The MFT is initially loaded and then circulated through the loop for 30 seconds prior to the addition of polymer powder. 1000 ppm of the polymer (dry polymer basis) is added as a continuous stream to the flowing MFT for 30 seconds (Example 3) and for 2 minutes (Example 4). After the addition of the powder, the treated MFT continued to mix in the flow loop for times ranging from 0 to 500 seconds. Finally, the treated stream is drained and collected in a 1 L graduated cylinder for dewatering monitoring FIG. 5.

### Examples 5 to 7

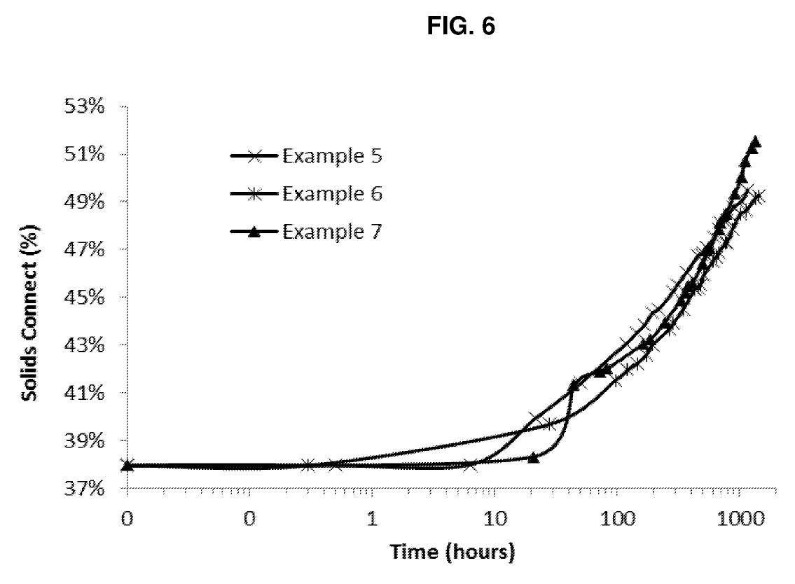

Using the method described for Example 3, flocculant powder was added to MFT using a 1 L flow loop. After the loading the MFT, it was circulated in the loop for 30 seconds prior to treatment. Next, the flocculant was added for 2 minutes at varying dosages of 1000 ppm (Example 5), 500 ppm (Example 6), and 150 ppm (Example 7). After mixing in the loop the samples were collected into graduated cylinders and monitored for dewatering FIG. 6.

What is claimed is:

1. A process for flocculating and dewatering an aqueous mineral suspension, comprising the steps:
(i) providing an in-line flow of an aqueous mineral suspension through a pipe,
(ii) introducing a powdered flocculant composition consisting of a poly(ethylene oxide) (co)polymer and optionally one or more additive that is not a flocculant composition into the aqueous mineral suspension flowing through the pipe,
(iii) mixing the powdered flocculant composition and the aqueous mineral suspension,
(iv) flowing the mixture of aqueous mineral suspension and flocculant composition through a pipe for further treatment and/or to a dedicated disposal area,
and
(v) forming a flocculated aqueous mineral suspension,
wherein step (v) may occur before and/or during and/or after step (iv).

2. The process of claim 1 wherein the mixing takes place in an in-line mixer.

3. The process of claim 1 further comprising the step:
(vi) adding the flocculated aqueous mineral suspension to at least one centrifuge to dewater the flocculated aqueous mineral suspension and form a high solids cake and a low solids centrate.

4. The process of claim 1 further comprising the step:
(vii) adding the flocculated aqueous mineral suspension to a thickener to dewater the flocculated aqueous mineral suspension and produce thickened flocculated aqueous mineral suspension and clarified water.

5. The process of claim 1 wherein the dedicated disposal area is at least one deep pit accelerated dewatering cell.

6. The process of claim 1 wherein the dedicated disposal area is a sloped deposition site further comprising the step:
(viii) spreading the mixture of aqueous mineral suspension and flocculant composition and/or the flocculated aqueous mineral suspension as a thin layer onto the sloped deposition site.

7. The process of claim 1 wherein the poly(ethylene oxide) (co)polymer composition comprises a poly(ethylene oxide) homopolymer, a poly(ethylene oxide) copolymer, or mixtures thereof.

8. The process of claim 9 wherein the poly(ethylene oxide) copolymer is a copolymer of ethylene oxide with one or more of epichlorohydrin, propylene oxide, butylene oxide, styrene oxide, an epoxy functionalized hydrophobic monomer, glycidyl ether functionalized hydrophobic monomer, a silane-functionalized glycidyl ether monomer, or a siloxane-functionalized glycidyl ether monomer.

9. The process of claim 1 wherein the poly(ethylene oxide) (co)polymer has a molecular weight of equal to or greater than 1,000,000 Da.
